(19) United States
(12) Patent Application Publication
(10) Pub. No.: US 2005/0247403 A1
(43) Pub. Date: Nov. 10, 2005

(54) Flock-adhesion to a plastic article

(75) Inventors: Dwight Siu Fai Chan, Hong Kong Sar (CN); On Tai Yung, Hong Kong Sar (CN)

Correspondence Address: ALIX YALE & RISTAS LLP, 750 MAIN STREET, SUITE 1400, HARTFORD, CT, 06103, US

(73) Assignee: Sun Cheong Toys Factory Limited

(21) Appl. No.: 10/838,797

(22) Filed: May 4, 2004

(51) Int. Cl. B32B 3/12; B05D 1/14

(52) U.S. Cl. 156/279; 156/242; 427/200

(57) ABSTRACT

A method of manufacturing a soft plastic article such as a toy horse having a coating of flock. The method includes molding or otherwise forming at least a part of the article from PVC plastics material having adhesive-incompatible stabilizers or additives therein. The adhesive-incompatible stabilizers or additives are dissolved out of the article. An adhesive coating is then applied to the article and flocking particles are applied to the adhesive coating.

### BACKGROUND OF THE INVENTION

The present invention relates to improving the adhesion of flocking particles to a plastic article. More particularly, although not exclusively, the invention relates to a method of improving the adhesion of imitation hair or fur to a plastic toy animal such as a horse or bear.

It is known to adhere dusty flocking particles of natural or synthetic fibre to the exterior of a plastic toy to imitate animal hair or fur. The known process applies adhesive to a “bald” semi-rigid plastic shell, followed by the application of the flocking particles. In order to adopt the known technique for soft plastic toys made of flexible inexpensive materials ouch as PVC, certain difficulties must be overcome. These relate primarily to the incorporation into the PVC materials of oily stabilizing additives that are incompatible with flock-securing adhesives. Other materials such as latex rubber do not have the stabilizing additives, but are too expensive.

### SUMMARY OF THE INVENTION

it is the object of the present invention to overcome or substantially ameliorate the above disadvantage and/or more generally to provide an improved method of manufacturing a soft plastic article having well-adhered flocking.

There is disclosed herein a method of manufacturing a soft plastic article having a coating of flock, comprising molding or otherwise forming at least a part of the article from plastic material having adhesive-incompatible stabilizers or additives therein, dissolving the adhesive-incompatible stabilizers or additives out of the article, applying an adhesive coating to the article, and applying flocking particles to the adhesive coating.

Preferably, the dissolving step comprises heating the article with liquid.

Preferably, the step of molding or otherwise forming comprises centrifugal molding.

Preferably, the heating step comprises immersing the article in heated water. Preferably, the adhesives is sprayed onto the article.

Preferably, the flock particles are applied by dipping the article in a vessel containing the particles.

Preferably, the article is of animal form.

Preferably, the method further comprises the step of manufacturing two or more the parts of the article, wherein each part is substantially hollow, filling the parts with padding material and a wire skeletal structure, and adhering the parts together so as to encase the padding material and wire skeletal structure, prior to the application of adhesive.

Preferably, the method further comprises the step of applying paint and/or other finishes to the coating of flock.

Preferably, the soft plastic material comprises PVC.

There is further disclosed herein a soft toy produced by the above-disclosed method in the form of an animal.

Other objects and advantages of the invention will become apparent from the drawings and specification.

### BRIEF DESCRIPTION OF THE DRAWINGS

The present invention may be better understood and its numerous objects and advantages will become apparent to those skilled in the art by reference to the accompanying drawings in which:

FIG. 1 is a schematic perspective illustration of a plastic mixing apparatus;

FIG. 2 is a schematic cross-sectional elevation of a mold for producing a pair of half-horse forms;

FIG. 3 is a schematic cross-sectional elevation of a centrifuge;

FIG. 4 is a schematic cross-sectional elevation of a toy horse; and

FIG. 5 is a schematic cross-sectional elevation of a half horse form in a boiling tank in which plastic additives are dissolved therefrom.

### DETAILED DESCRIPTION OF THE PREFERRED EMBODIMENT

In the accompanying drawings there is depicted schematically various steps in the manufacture of a flock-coated toy horse. It should be appreciated however that the process disclosed herein can be applied to articles other than animals such as human-formed figurines for example.

In FIG. 1 there is shown a PVC mixing station 10 comprising a tank 11 having a lid 12 upon which there is mounted an electric motor 13 driving and agitator 15 via a gearbox 14. The agitator 15 depends into a mass of liquid PVC material that can be drawn off via a tap 16 into mold halves 17, each having a handle 18.

The mold halves each comprise a pair of horse-shaped recesses 19 that are depicted in transverse cross-section for illustration purposes only.

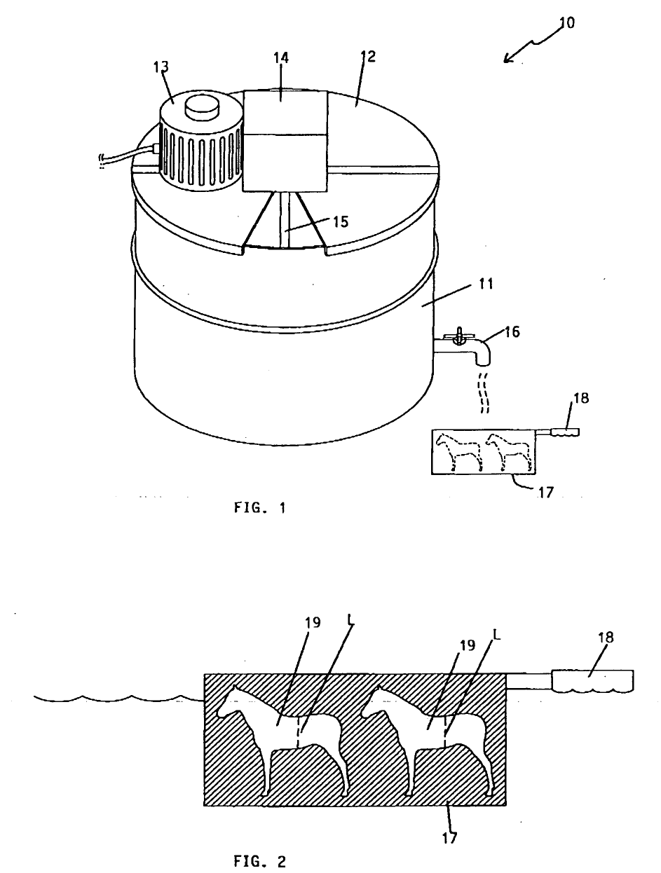

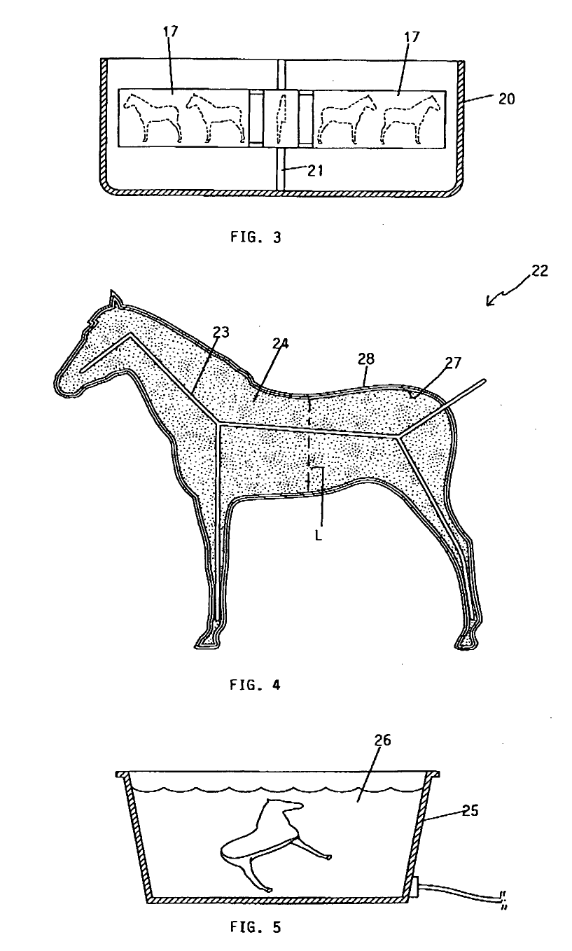

It should be noted that the horse halves would in fact be delineated transversely across the midsection as shown by the dotted lines in FIG. 2. That is, once the horse halves are ready to be assembled, the minimum amount of adhesive can be used where the halves are joined across the midsection rather than across a longitudinal join about the whole body.

After the PVC material is poured into the molds as shown in FIG. 1, the mold halves are inserted into a basket of a centrifuge 20 wherein the PVC material is forced against the inside surface of the mold 17 under centrifugal force as the baskets are driven to rotate about a central shaft 21 at high speed.

To complete the curing process, the molds are immersed in boiling paraffin at 150° C. (melting point 120° C.) for about 15 minutes. After the paraffin has “cooked” or cured, the PVC forms the soft “skin” of the horse.

The horse halves are then removed from the molds and immersed in boiling water as shown in FIG. 5. To this end, a heating vessel 25 contains water 26. Detergent could be added to the water is desired. The pieces can be boiled for 15 minutes for example to remove oily stabilizers or additives from the PVC.

A toy horse is shown in FIG. 4 and includes a wire skeleton 23 surrounded by padding 24. The padding is typically polyester or other synthetic material. The horse parts are glued together along the joint L to form a flexible shell encasing the skeleton 23 and padding 24. Adhesive in then sprayed onto the horse exterior to form an adhesive layer 27. Before the adhesive cures, the horse is dipped into a vessel containing dry flocking of wool or other natural or synthetic fiber such as nylon. The adhesive Is then allowed to dry to adhere the flocking to the horse exterior.

The horse can then be dressed by spray-painting through paint masks, hand painting, or the addition of a saddle, mane and tail as desired.

It should be appreciated that modifications and alterations obvious to those skilled in the art are not to be considered as beyond the scope of the present invention. For examples the process of removing the oily additives from the PVC might use solvents, steam, steam jet or liquid jet.

1. A method of manufacturing a soft plastic article having a coating of flock, the method comprising:
molding or otherwise forming at least a part of the article from plastic material having adhesive-incompatible stabilizers or additives therein;
dissolving the adhesive-incompatible additives out of the article;
applying an adhesive coating to the article; and
applying flocking particles to the adhesive coating.

2. The method of claim 1 wherein the dissolving step comprises heating the article with liquid.

3. The method of claim 1 wherein the step of molding or otherwise forming comprises centrifugal molding.

4. The method of claim 2 wherein the heating step comprises immersing the article in heated water.

5. The method of claim 1 wherein the adhesive is sprayed onto the article.

6. The method of claim 1 wherein the flock particles are applied by dipping the article in a vessel containing the particles.

7. The method of claim 1 wherein the article is of animal form.

8. The method of claim 1 further comprising the step of manufacturing a plurality of said parts of the article, wherein each part is substantially hollow, filling the parts with padding material and a wire skeletal structure, and adhering the parts together so as to encase the padding material and wire skeletal structure, prior to said application of adhesive.

9. The method of claim 8 further comprising the step of applying paint and other finishes to the coating of flock.

10. The method of claim 1 wherein the soft plastic material comprises PVC.

11. The method of claim 8 further comprising the step of applying paint or other finishes to the coating of flock.

12. A soft toy having the form of an animal comprising:
a shell molded or otherwise formed at least in part from plastic material having adhesive-incompatible stabilizers or additives therein, the adhesive-incompatible additives being dissolved out of the shell;
an adhesive coating applied to the shell; and
flocking particles applied to the adhesive coating.
